(19) United States
(12) Patent Application Publication
(10) Pub. No.: US 2009/0186654 A1
(43) Pub. Date: Jul. 23, 2009

(54) Method of automatically playing text information in voice by an electronic device under strong light

(75) Inventors: Liang Chen, Nanjing (CN); Zheng-Rong Zou, Nanjing (CN)

Correspondence Address: BACON & THOMAS, PLLC, 625 SLATERS LANE, FOURTH FLOOR, ALEXANDRIA, VA, 22314-1176, US

(73) Assignee: Inventec Appliances Corp., Taipei (TW)

(21) Appl. No.: 12/318,676

(22) Filed: Jan. 6, 2009

(30) Foreign Application Priority Data
Jan. 21, 2008 (TW) 097102151

(51) Int. Cl. H04M 1/00; G10L 13/08

(52) U.S. Cl. 455/556.1; 704/260

(57) ABSTRACT

A method of automatically playing text information in voice by an electronic device under strong light is applied to an electronic device (such as a mobile phone). The device includes a light sensor, a text to speech unit, and a display such as a liquid crystal display. The light sensor detects an intensity of ambient light, and when the intensity is greater than a predetermined value, the text to speech unit will convert text information (such as a textual description or short message) into corresponding voice signals, and an audio speaker (such as a loudspeaker or earphone) of the electronic device plays the voice signals. When users can not view the text information on the screen clearly under strong light, the electronic device can read the text information and play the text information in voice, and users can still listen to the desired text information under strong light by the method.

### FIELD OF THE INVENTION

The present invention relates to a method of showing text information, and more particularly to a method enabling an electronic device (such as a mobile phone) to determine whether or not to play text information shown on a display (such as a liquid crystal display) of the electronic device in voice through an audio speaker of the electronic device when detecting that the intensity of the ambient light exceeds a predetermined value.

### BACKGROUND OF THE INVENTION

In recent years, the electronic industry blooms and various electronic devices including mobile phones, personal digital assistants (PDAs) and global positioning systems (GPSs) are introduced continuously to the market, and these electronic devices not only come with different functions, and a light, thin, short and compact design, but also offer an increasingly lower price, such that the electronic devices become affordable consumer products used extensively in our daily life and work, and necessary tools indispensible to our life and work, and also bring tremendous convenience to our life and work.

In general, the electronic devices usually install a liquid crystal display (LCD) provided for a user to view various information (such as a textual description or short message). Since the liquid crystal display technology still encounters a bottlenecks that users cannot view the information displayed on the liquid crystal display clearly under strong light, therefore the users cannot use the functions of the electronic devices normally under the environment with strong light or maximize the functions of the electronic devices.

As described above, the electronic devices not only provide different functions, but also provide convenient operations to users. More importantly, the information required for various operations can be shown correctly and clearly, such that the users can obtain instant information or operate the required functions correctly. Therefore, it is an important subject for related manufacturers to design and develop a novel electronic device, such that users can operate the electronic device and obtain information correctly and clearly under the environment of strong light, so as to overcome the shortcomings of the prior art.

### SUMMARY OF THE INVENTION

In view of the foregoing shortcomings of the prior art, the inventor of the present invention based on years of experience in the related industry to conduct extensive researches and experiments, and finally invented a method of automatically playing text information in voice by an electronic device under strong light, in hope of effectively overcoming the shortcomings that users cannot view the text information displayed on the display of the electronic device clearly under the environment of strong light.

Therefore, it is a primary objective of the present invention to provide a method of automatically playing text information in voice by an electronic device under strong light, and the method is applied to the electronic device, and the electronic device comprises a light sensor, a text-to-speech unit, a display (such as a liquid crystal display) and an audio speaker. In the method, a light sensor is used for detecting an intensity of ambient light which is compared with a predetermined value. when the intensity of the ambient light exceeds a predetermined value, then the electronic device will retrieve text information (such as a textual description or short message) displayed on a display such that a text-to-speech unit can be used for converting the text information into a corresponding voice, and an audio speaker is used for playing a voice signal, such that the user can still listen to a voice of the text information to operate the electronic device under strong light by playing the text information in voice in accordance with the method of the present invention, even though the user cannot view the text information on the display clearly.

The objects, technical characteristics and effects of the present invention will become apparent from the following detailed description taken with the accompanying drawings.

### BRIEF DESCRIPTION OF THE DRAWINGS

FIG. 1 is a schematic block diagram of an electronic device of the invention;

FIG. 2 is a flow chart of a first preferred embodiment of the invention; and

FIG. 3 is a flow chart of a second preferred embodiment of the invention;

### DETAILED DESCRIPTION OF THE PREFERRED EMBODIMENTS

To make it easier for our examiner to understand the technical characteristics of the present invention, we use preferred embodiments together with the accompanying drawings for the detailed description of the invention as follows:

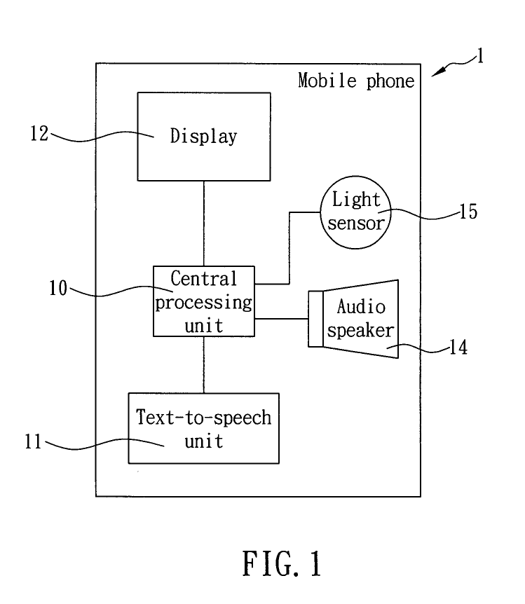

With reference to FIG. 1 for a schematic block diagram of an electronic device that adopts a method of automatically playing text information in voice under strong light in accordance with a preferred embodiment of the invention, the method is applied in the electronic device such as a mobile phone, a personal digital assistant (PDA) or a global positioning system (GPS), and the electronic device is a mobile phone in this embodiment. The mobile phone 1 comprises a central processing unit (CPU) 10, a text-to-speech unit 11, a display 12 (such as a liquid crystal display), an audio speaker 14 (such as a loudspeaker and an earphone) and a light sensor 15, wherein the CPU 10 is coupled to the text-to-speech unit 11, the display 12, the audio speaker 14 and the light sensor 15, and the aforementioned components are controlled for the processing according to the method of the present invention. In the method, the light sensor 15 of the mobile phone 1 detects an intensity of ambient light, and the detection result is transmitted to the CPU 10 and compared with a predetermined value. when the intensity of ambient light is greater than the predetermined value, then the CPU 10 will retrieve text information (such as a textual description or short message) displayed on the display 12. After the text information is retrieved, the text-to-speech unit 11 will convert the text information into a corresponding voice signal, and the audio speaker 14 will play a voice signal, so that a user can still listen to the voice played from the mobile phone 1 directly, even if the user cannot view the text information displayed on the display 12 clearly.

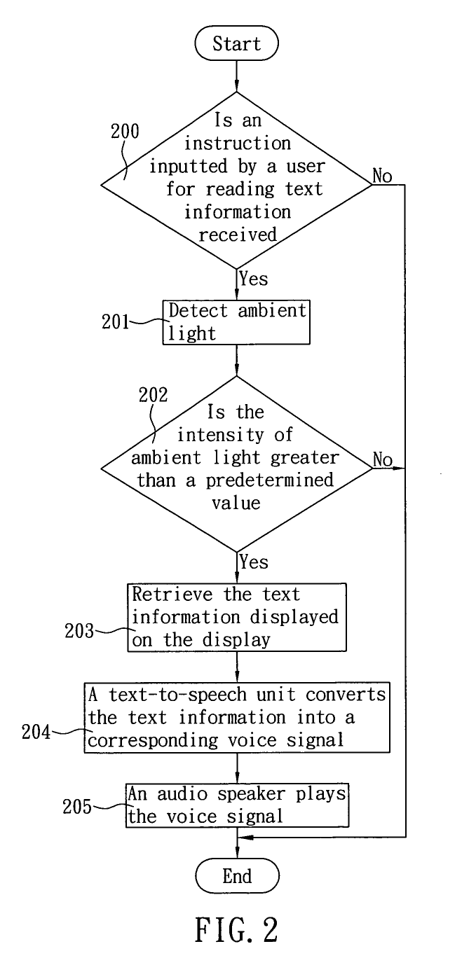

With reference to FIG. 2 for a method of a first preferred embodiment of the invention, the method controls the components when a user turns on the mobile phone 1 according to the following steps:

Step (200): The mobile phone 1 determines whether or not an instruction inputted by a user for reading text information is received; if yes, then go to Step (201), or else end the procedure.

Step (201): Turn on a light sensor 15 for detecting an intensity of ambient light by the light sensor.

Step (202): Determine whether or not the intensity of ambient light corresponding to a detected signal transmitted from the light sensor 15 is greater than a predetermined value; if yes, then go to Step (203), or else end the procedure after displaying the desired text information on a display.

Step (203): Retrieve the text information displayed on the display 12.

Step (204): A text-to-speech unit 11 converts the text information into a corresponding voice signal.

Step (205): An audio speaker 14 plays the text information displayed on the display 12 in voice, such that the user can listen to the voice.

For example, when a user is situated outdoors and under strong sunlight, and possesses a mobile phone 1 for receiving a short message, and wants to view the short message immediately, the user simply turns on a light sensor 15 of the mobile phone 1 for detecting an intensity of ambient light and determining whether or not the intensity of strong light exceeds a predetermined value, after an instruction for reading the short message is inputted, and the short message is displayed on the display 12 for retrieving the text. The text-to-speech unit 11 converts the retrieved text into a corresponding voice signal, and an audio speaker 14 is provided for playing the voice signal, such that when a user reads a short message under strong light, the mobile phone 1 will play the text information displayed on the display 12 in voice in accordance with the present invention, and the user can still listen to the short message which cannot be viewed clearly on the display 12 under strong light. Therefore, a user simply needs to have a mobile phone 1 that adopts the present invention in order to assure viewing or listening to the required short message under strong light, and thus the function of the mobile phone 1 can be more comprehensive to achieve the effects of using, operating and controlling the mobile phone.

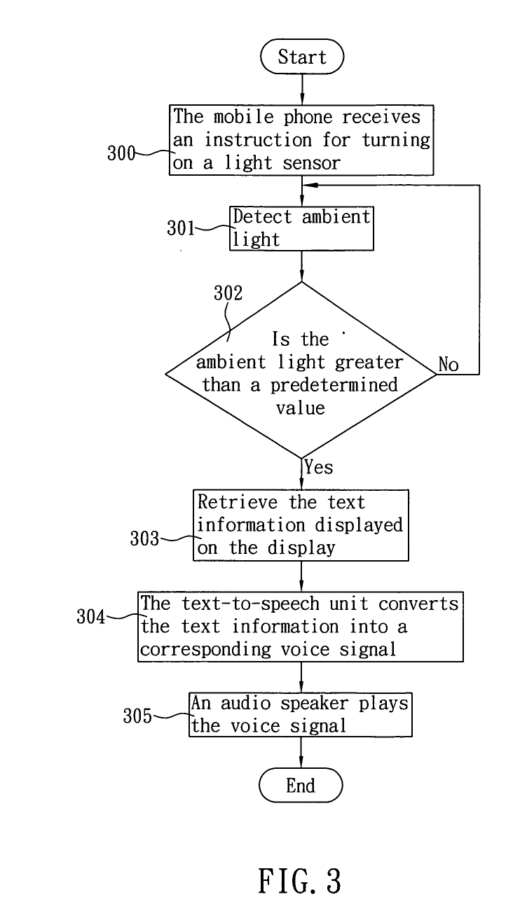

In the description above, a preferred embodiment is used for illustrating the present invention only, but the practical application of the invention is not limited to such embodiment only. With reference to FIG. 3 for a second preferred embodiment of the present invention, the method carries out the following steps after the user turns on the mobile phone 1:

Step (300): The mobile phone 1 receives an instruction from a user to turn on a light sensor.

Step (301): Turn on the light sensor 15 for detecting an intensity of ambient light continuously.

Step (302): Determine whether or not the intensity of ambient light is greater than a predetermined value; if yes, go to Step (303), or else go to Step (301) for driving the light sensor 15 to detect the intensity of ambient light continuously, and displaying the desired text information on a display 12.

Step (303): Retrieve the text information displayed on the display 12.

Step (304): The text-to-speech unit 11 converts the text information into a corresponding voice signal.

Step (305): An audio speaker 14 plays the text information displayed on the display 12 in voice which is provided for the user to listen.

Therefore, the mobile phone 1 can detect the ambient light in accordance with the present invention anytime after the light sensor 15 is turned on. For example, when a user uses the mobile phone 1 to browse information of a webpage, and the user is situated at a place with fast-varying light (such as transportation means), the user simply turns on the light sensor 15, and the mobile phone 1 will determine the intensity of ambient light according to the method of the present invention continuously. The information of the currently browsed webpage is displayed on the display 12 automatically for the user's view in the condition of a lower intensity of ambient light, or the information of the currently browsed webpage is retrieved automatically in the condition of a higher intensity of ambient light. The text-to-speech unit 11 converts the text information into a voice signal, and the audio speaker 14 plays the voice signal provided for the user to listen. Therefore, when the user browses the information of a webpage on the mobile phone 1, the display will not be affected by the intensity of strong light, so that the user has to stop or pause the browsing. The present invention can provide a more comprehensive function to the mobile phone 1 in accordance with the method of the present invention, so as to achieve the effect of providing a more convenient application for users.

While the invention has been described by means of specific embodiments, numerous modifications and variations could be made thereto by those skilled in the art without departing from the scope and spirit of the invention set forth in the claims.

What is claimed is:

1. A method of automatically playing text information in voice by an electronic device under strong light, which is applied in an electronic device comprising a central processing unit (CPU), a light sensor, a text-to-speech unit, a display and an audio speaker, and activates the CPU to execute a procedure comprising the steps:
receiving a detection signal of an intensity of ambient light transmitted from the light sensor;
retrieving the text information displayed on the display, when the intensity of ambient light represented by the detection signal is greater than a predetermined value;
the text-to-speech unit converting the text information into a corresponding voice signal; and
playing the voice signal through the audio speaker.

2. The method of claim 1, further comprising the step of determining whether or not an instruction inputted by a user for reading the text information is received, before the detection signal of the intensity of ambient light transmitted from the light sensor is received.

3. The method of claim 1, further comprising the step of determining whether or not an instruction inputted by a user for turning on the light sensor is received, before the detection signal of the intensity of ambient light transmitted from the light sensor is received.

4. The method of claim 1, wherein the electronic device is a personal digital assistant.

5. The method of claim 2 wherein the electronic device is a personal digital assistant.

6. The method of claim 3, wherein the electronic device is a personal digital assistant.

7. The method of claim 1, wherein the electronic device is a mobile phone.

8. The method of claim 2, wherein the electronic device is a mobile phone.

9. The method of claim 3, wherein the electronic device is a mobile phone.

10. The method of claim 1, wherein the electronic device is a global positioning system.

11. The method of claim 2, wherein the electronic device is a global positioning system.

12. The method of claim 3, wherein the electronic device is a global positioning system.
